(19) United States
(12) Patent Application Publication
(10) Pub. No.: US 2016/0103351 A1
(43) Pub. Date: Apr. 14, 2016

(54) FAST ELECTROOPTIC SWITCHING DEVICES EMPLOYING POLYMER TEMPLATE SHAPED BY BLUE PHASE LIQUID CRYSTAL

(71) Applicant: KENT STATE UNIVERSITY, Kent, OH (US)

(72) Inventors: Oleg D. Lavrentovich, Kent, OH (US); Jie Xiang, Kent, OH (US)

(21) Appl. No.: 14/894,688

(22) PCT Filed: May 30, 2014
(86) PCT No.: PCT/US14/40174

§ 371 Date: Nov. 30, 2015

Related U.S. Application Data
(60) Provisional application No. 61/828,732, filed on May 30, 2013.

(51) Int. Cl. G02F 1/133; G02F 1/1341; G02F 1/1335

(52) U.S. Cl. CPC G02F 1/13306; G02F 1/133528; G02F 1/1341; G02F 2001/13775

(57) ABSTRACT

A phase retarder includes a liquid crystal cell and electrical switching circuitry. The liquid crystal cell contains electrodes and an active layer comprising liquid crystal material stabilized by a polymer network that is shaped by a blue phase using a washout/refill procedure. The electrical switching circuitry is configured to operate the phase retarder at a switching speed of less than 500 microseconds for both rise time and decay time, and in some embodiments is configured to operate the phase retarder at a switching speed of 200 microseconds or less for both rise time and decay time. The polymer network typically has pores of less than or about 200 nm. The liquid crystal material may be a nonchiral nematic liquid crystal material, a chiral nematic liquid crystal material, or a chiral smectic liquid crystal material. In some embodiments the liquid crystal cell does not include an alignment layer.

This application is a national stage entry of PCT/US2014/040174 filed May 30, 2014 and titled “FAST ELECTROOPTIC SWITCHING DEVICES EMPLOYING POLYMER TEMPLATE SHAPED BY BLUE PHASE LIQUID CRYSTAL” which claims the benefit of U.S. Provisional Application No. 61/828,732 filed May 30, 2013 and titled “FAST ELECTROOPTIC SWITCHING DEVICES EMPLOYING POLYMER TEMPLATE SHAPED BY BLUE PHASE LIQUID CRYSTAL”. U.S. Provisional Application No. 61/828,732 filed May 30, 2013 and titled “FAST ELECTROOPTIC SWITCHING DEVICES EMPLOYING POLYMER TEMPLATE SHAPED BY BLUE PHASE LIQUID CRYSTAL” is hereby incorporated by reference in its entirety.

This invention was made with Government support under grant/contract no. NSF DMR 1121288 awarded by the National Science Foundation (NSF). The Government has certain rights in this invention.

### BACKGROUND

The following relates to the high-speed optical switching devices, high-speed phase retarder devices, high-speed intensity modulation devices, display technologies, fiber optical communication technologies, and related arts.

Liquid crystal materials are widely used as optical modulators, for example as display pixels (e.g. in televisions, computer monitors, and so forth), as signal modulators in fiber optical communications, and so forth.

However, a significant difficulty is that the switching speeds achievable with liquid crystal devices have heretofore been relatively slow, exhibiting switching speeds typically no better than 0.5 msec (that is, 0.5 milliseconds, also suitably written as 500 microseconds or 500 μs), and the switching speed is of order several milliseconds in many liquid crystal devices. These relatively slow switching speeds are insufficient for some applications such as three-dimensional (3D) television, field-sequential display technologies, high speed fiber optical communication links, and so forth.

Another difficulty with some liquid crystal devices is the need to provide an alignment layer on one or both substrate surfaces. This increases processing, and formation of the alignment layer by conventional techniques such as mechanical rubbing can introduce contaminants into the device and adversely impact device fabrication yield.

### BRIEF SUMMARY

In some illustrative embodiments disclosed herein, an apparatus comprises a phase retarder including a liquid crystal cell containing electrodes and an active layer comprising liquid crystal material stabilized by a polymer network that is shaped by a blue phase using a washout/refill procedure, and electrical switching circuitry operatively connected with the electrodes of the phase retarder and configured in cooperation with the phase retarder to switch the phase retarder over its dynamic range with both a 10%-to-90% rise time of less than 500 microseconds and a 90%-to-10% decay time of less than 500 microseconds. In some embodiments, the electrical switching circuitry is configured in cooperation with the phase retarder to switch the phase retarder over its dynamic range with both a 10%-to-90% rise time of 200 microseconds or less and a 90%-to-10% decay time of 200 microseconds or less. In some embodiments the electrical switching circuitry is configured in cooperation with the phase retarder to switch the phase retarder over its dynamic range with both a 10%-to-90% rise time of 200 microseconds or less and a 90%-to-10% decay time of 200 microseconds or less over a temperature range of at least 30° C. In some embodiments the electrical switching circuitry is configured in cooperation with the phase retarder to switch the phase retarder over its dynamic range with both a 10%-to-90% rise time of less than 500 microseconds and a 90%-to-10% decay time of less than 500 microseconds over a temperature range of at least 30° C. The dynamic range of the phase retarder may be suitably defined in some embodiments as the phase retardation range obtainable by biasing the electrodes of the phase retarder. In other embodiments, the apparatus further comprises polarizers disposed on opposite sides of the phase retarder, and the dynamic range of the phase retarder is defined as the range of light transmission intensity through the optical assembly comprising the phase retarder and the polarizers obtainable by biasing the electrodes of the phase retarder. In some embodiments the polymer network has pores of less than or about 200 nm. The liquid crystal material may, by way of illustrative example, comprise a nonchiral nematic liquid crystal material, a chiral nematic liquid crystal material, or a chiral smectic liquid crystal material. In some embodiments the phase retarder does not include an alignment layer. The polymer network may comprise a polymer network that is shaped by a blue phase of type I having a body-centered cubic structure using a washout/refill procedure.

In some illustrative embodiments disclosed herein, a display includes an array of pixels, in which each pixel of the array of pixels includes an instance of the phase retarder of the immediately preceding paragraph sandwiched between polarizers. The display further includes the electrical switching circuitry of the immediately preceding paragraph comprising pixel driver circuitry operatively connected with the electrodes of the phase retarder of each pixel of the array of pixels. The display still further includes a display controller comprising an electronic component programmed to generate and communicate to the electrical switching circuitry electrical signals indicating gray scale values for the pixels of the array of pixels. In such a display embodiment, the dynamic range of the phase retarder is suitably defined as the range of gray scale intensity obtainable by biasing the electrodes of the phase retarder.

In some illustrative embodiments disclosed herein, a method comprises: providing a phase retarder including a liquid crystal cell containing electrodes and an active layer comprising liquid crystal material stabilized by a polymer network that is shaped by a blue phase using a washout/refill procedure; and applying voltages to the electrodes of the phase retarder to switch the phase retarder over its phase retardation dynamic range obtainable by biasing the electrodes of the phase retarder with both a 10%-to-90% rise time of less than 500 microseconds and a 90%-to-10% decay time of less than 500 microseconds. In some embodiments the applying comprises applying voltages to the electrodes of the phase retarder to switch the phase retarder over its phase retardation dynamic range with both a 10%-to-90% rise time of 200 microseconds or less and a 90%-to-10% decay time of 200 microseconds or less. In some embodiments the providing comprises shaping the polymer network by a blue phase of type I having a body-centered cubic structure using a washout/refill procedure.

In some illustrative method embodiments of the immediately preceding paragraph, the providing comprises performing the washout/refill procedure by operations including: filling the liquid crystal cell with a first mixture comprising a nematic liquid crystal, a chiral dopant, a reactive monomer, and a photoinitiator; controlling temperature of the liquid crystal cell containing the first mixture to convert the first mixture to a blue phase; irradiating the liquid crystal cell with the first mixture in the blue phase with ultraviolet light at a wavelength and exposure duration effective to polymerize the reactive monomer to form a three-dimensional polymer network inside the liquid crystal cell; disposing the liquid crystal cell in a solvent to wash out the first mixture while leaving the three-dimensional polymer network in the liquid crystal cell; and refilling the liquid crystal cell with the liquid crystal material of the active layer.

In some illustrative embodiments disclosed herein, an apparatus comprises: a phase retarder including a liquid crystal cell containing electrodes and an active layer comprising liquid crystal material stabilized by a polymer network that is shaped by a blue phase using a washout/refill procedure; and electrical switching circuitry configured to operate the phase retarder at a switching speed of less than 500 microseconds for both rise time and decay time. In some embodiments the electrical switching circuitry is configured to operate the phase retarder at a switching speed of 200 microseconds or less for both rise time and decay time. In some embodiments the polymer network has pores of less than or about 200 nm. In some embodiments the liquid crystal material comprises a nonchiral nematic liquid crystal material, a chiral nematic liquid crystal material, or a chiral smectic liquid crystal material. In some embodiments the liquid crystal cell does not include an alignment layer.

### BRIEF DESCRIPTION OF THE DRAWINGS

The drawings are described in the referencing text in this application. Except where otherwise indicated, the drawings are understood to be diagrammatic and not to scale.

FIG. 1 diagrammatically shows a display comprising an array of pixels, one of which is diagrammatically shown in diagrammatic cross-section in the inset at upper-left.

FIGS. 2(a) and 2(b) show polarizing optical microscope textures of blue phase material in mixture with monomers: before photo-polymerization (FIG. 2(a)), and after photo-polymerization (FIG. 2(b)).

FIG. 2(c) shows polarizing optical microscope texture after removing the liquid crystal.

FIG. 2(d) shows the periodic polymer-network shaped by the blue phase under scanning electron microscopy (SEM).

FIGS. 2(e) and 2(f) diagrammatically show the arrangement of disclination lines in blue phase type I (BPI) in a perspective view (FIG. 2(e)) and in a side view (FIG. 2(f)) which coincides with the SEM image of FIG. 2(d).

FIG. 3 shows polarizing optical microscope images of a refilled blue phase-template E7 sample during cooling from isotropic to blue phase.

FIG. 4 diagrammatically shows a plan view of an in-plane-switching (IPS) cell used to study electro-optical performance.

FIG. 5 shows polarizing optical microscope images of a blue phase template E7 sample under applied voltage at room temperature.

FIG. 6 plots phase retardance of a blue phase template E7 sample versus applied electric field by running three cycles from 0→12 Volts/μm and back 12→0 Volts/μm.

FIG. 7 plots Kerr constant estimated by repeating the phase retardance measurement of FIG. 6 at different temperature.

FIG. 8 diagrammatically shows an experimental setup for measuring electrooptic device response time.

FIG. 9 shows applied voltage as a function of time measured by a digital oscilloscope (upper trace), and normalized transmittance as a function of time as measured by the detector of the experimental setup shown in FIG. 8 (lower trace).

FIG. 10 plots rise time τₒₙ and the decay time τ_{off} as a function of temperature obtained by repeating the experiment of FIG. 9 at temperatures between 25° C. and 55° C.

### DETAILED DESCRIPTION

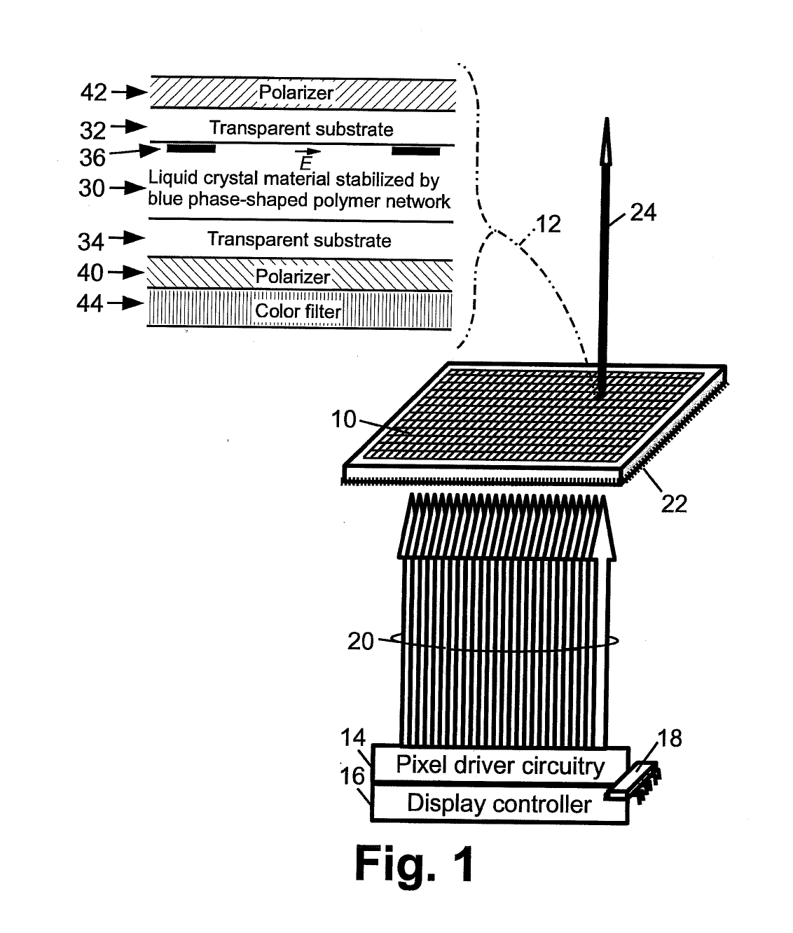

With reference to FIG. 1, a display comprises an array of pixels 10, one of which is diagrammatically shown in the inset 12 at upper-left, driven by pixel driver circuitry 14 controlled by a display controller 16. The pixel driver circuitry 14 and display controller 16 are embodied by suitable electronics, such as a diagrammatically illustrated discrete integrated circuit (IC) chip 18 (or a combination of IC circuits, e.g. a microprocessor and read-only memory (optionally erasable) containing programming executed on the microprocessor. The IC chip(s) are optionally mounted on a backside of a circuit board supporting the pixel array 10, or may be constructed as electronics partly or wholly monolithically integrated with the pixel array 10, e.g. including thin-film transistor (TFT) driver elements. The electronics 14, 16 may be variously distributed—for example, the pixel driver circuitry 14 may be integrated on the backside of the substrate supporting the pixel array 10, while the display controller 16 may be a separate element. The display controller 16 is programmed to generate signals indicating the gray scale values for the pixels, for example so as to generate a raster display, field-sequential display, three-dimensional (3D) display, or so forth. The pixel driver circuitry 14 receives these control signals from the display controller 16 and generates a (generally time-varying) drive voltage 20 for each pixel 12 of the array 10. (In FIG. 1 these voltages 20 are diagrammatically indicated by block arrows directed from the pixel driver circuitry 14 to the pixel array 10.) For example, the drive voltages 20 may be generated using digital-to-analog (D/A) converters. Not illustrated in FIG. 1 are “upstream” electronics such as television receiver circuitry, computer display circuitry, or so forth that generate and transmit the display pattern to the display controller 16 for rendering on the pixel array 10.

A backlight, such as a diagrammatically illustrated (LED)-based backlight 22 integrated into the pixel array 10, generates illumination that is modulated by the pixel array 10. In other embodiments, the backlight is suitably an incandescent, fluorescent, or halogen backlight lamp which may be integrated with or separate from the pixel array 10. Light from the backlight 22 passes through the pixel array 10 and is modulated by the pixels to transform the input backlighting into modulated display light output. For illustrative purposes, light 24 output after processing by illustrative pixel 12 is diagrammatically indicated.

The illustrative pixel 12 includes an active layer 30 comprising liquid crystal material stabilized by a polymer network that is shaped by a blue phase using a washout/refill procedure. The liquid crystal/polymer network layer 30 is disposed in a liquid crystal cell sandwiched between transparent substrates 32, 34, one or both of which include electrodes 36 disposed on the side contacting the active layer 30. In illustrative FIG. 1 only one substrate 32 includes such electrodes 36, which generate an in-plane or lateral electric field \vec{E} oriented parallel with the surface of the substrate 32 and extending partway or completely through a cell gap G between the substrates 32, 34. However, it is alternatively contemplated to include electrodes on both substrates so as to generate an electric field (or field component) oriented transverse to the surfaces of the substrates.

The liquid crystal cell comprising active layer 30 sandwiched between substrates 32, 34 and including electrodes 36 defines an electrically controlled phase retarder whose phase retardation is controlled by the electrical bias applied to the electrodes 36. Such a device may be useful by itself, for example in a modulator for certain types of fiber optical communication systems that employ phase modulation. For the illustrative display application, the phase retarder 30, 32, 34 is converted to an intensity modulator (i.e. gray scale pixel 12) by further inclusion of polarizers 40, 42. (Note that in the art one of these polarizers is sometimes referred to as an analyzer). For a color display, a color filter 44 is typically provided, with various pixels of the pixel array 10 having different-color filters, e.g. red, green, or blue color filters to implement red, green, and blue pixels, respectively. Alternatively, in a field-sequential display configuration the color filter 44 is omitted and instead the backlight 22 is cycled between, e.g., red, green, and blue color output cycling faster than the human eye response.

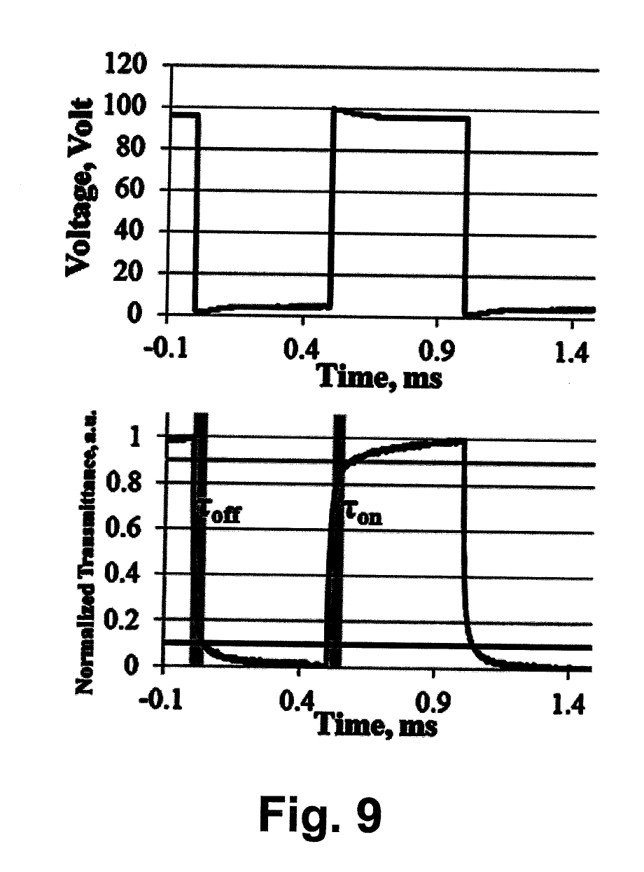

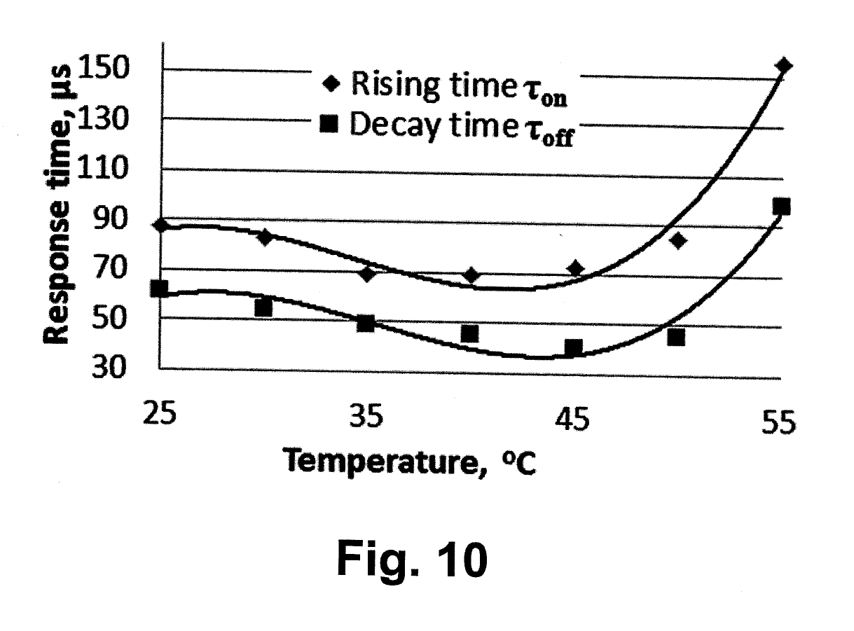

In some applications of interest, the pixel driver circuitry 14 (or other electronic controller applying voltage to the electrodes 36) operates at high speed, for example switching the pixel 12 between minimum and maximum transmission levels (corresponding to switching the phase retarder 30, 32, 34, 36 between minimum and maximum operative phase retardation levels) at a minimum→maximum transition time interval (“rise time” τₒₙ) and a maximum→minimum transition time interval (“decay time τ_{off}) of each less than one millisecond, and preferably less than 500 microseconds, and still more preferably at 200 microseconds or less (where the transition is measured between 10% of the minimum and 90% of the maximum, see illustrative FIG. 9). Moreover, the pixels of the pixel array 10 preferably maintain such fast switching speeds over a wide temperature range, such as a temperature range of at least 30° C., e.g. a temperature range [25° C., 55° C.] (see illustrative FIG. 10).

It is disclosed herein that suitably fast-switching liquid crystal devices are achievable using active layer 30 comprising liquid crystal material stabilized by a polymer network that is shaped by a blue phase using a washout/refill procedure. Without being limited to any particular theory of operation, it is believed that the unexpectedly high switching speeds obtained for these liquid crystal devices are due to a small pore size of around 200 nm observed for the blue-phase shaped polymer network, together with improved temperature stability of the refill liquid crystal material as compared with that of the blue phase of the liquid crystal material used to shape the polymer network.

In the following, fabrication and testing is described of some actually constructed liquid crystal devices including the active layer 30 comprising liquid crystal material stabilized by a polymer network that is shaped by a blue phase using a washout/refill procedure.

Blue phases of liquid crystal materials are an example of a frustrated soft matter system. They are formed by chiral molecules that tend to arrange locally into structures with two axes of twist (so-called double twist). However, the double-twist structure cannot extend itself to fill the entire volume of the liquid crystal cell defined between the substrates 32, 34. Rather, the double-twist structure is stabilized by a lattice of topological defects known as disclinations. A disclination is a defect in the orientation of the liquid crystal director ordering, and is roughly analogous to a dislocation in a crystal which is a defect in positional order. At the cores of disclinations, the orientational order is reduced, so that the material can be considered as partially melted. A consequence of this is that the blue phase in single compounds is typically observed only within a close proximity of the isotropic liquid phase. Depending on the arrangement of ordered and disordered regions, three classes of the blue phase can be distinguished: blue phase type I (BPI) which has a body-centered cubic structure; blue phase type II (BPII) which has a simple cubic structure; and blue phase type III (BPIII) which comprises an amorphous lattice. In the absence of an electric field, the all three types of blue phase are optically isotropic and show no birefringence. An applied electric field \vec{E} lifts the symmetry and causes birefringence that is described as a Kerr effect, Δn_{E}=λKE², where λ is the wavelength of light at which the birefringence is measured, K is the Kerr constant, generally on the order of 10⁻¹⁰ m/V² to 10⁻⁹ m/V², and E=|\vec{E}| is the magnitude of the applied electric field.

A problem with employing liquid crystal material in a blue phase is that liquid crystal materials known to enter the blue phase are found to maintain the blue phase only over a narrow temperature range near the isotropic liquid phase. This makes such devices undesirable for commercial applications such as displays. Improved temperature stability has been obtained by employing a polymer-stabilized blue phase in which the blue phase is stabilized by a polymer network. Kikuchi et al., Nat Mater vol. 1 no. 1 page 64 (2002); Coles et al., Nature vol. 436 (7053), page 997 (2005); Hyunseok et al., Appl Phys Lett vol. 101 page 13 (2012). Polymer-stabilized blue phase materials have been shown to be operative over a wider temperature range as compared with blue phase materials. Another known variant is to employ a washout-and-refill operation to produce a polymer network that is shaped by the blue phase of a liquid crystal material, and then to wash out the liquid crystal material providing the blue phase and refill the liquid crystal cell (with the blue phase-shaped polymer network remaining in place) using a refill liquid crystal material having more favorable temperature stability characteristics. See Castles et al., Nat Mater vol. 11 no. 7, page 599 (2012). Castles et al. disclosed the washout-and-refill method produces chiral blue phase-like structures when the blue phase-templated polymer is refilled with a non-chiral nematic liquid crystal.

However, it has been reported that polymer stabilization of the blue phase introduces substantial hysteresis into the electrooptic response. Chen et al., J Disp Technol vol. 6 no. 8, page 318 (2010). The hysteresis produces a different optical birefringence when the field is increased versus when the field is decreased, and also leads to build-up and enhancement of residual birefringence after multiple cycles of switching. These effects make such devices undesirable for commercial applications such as displays.

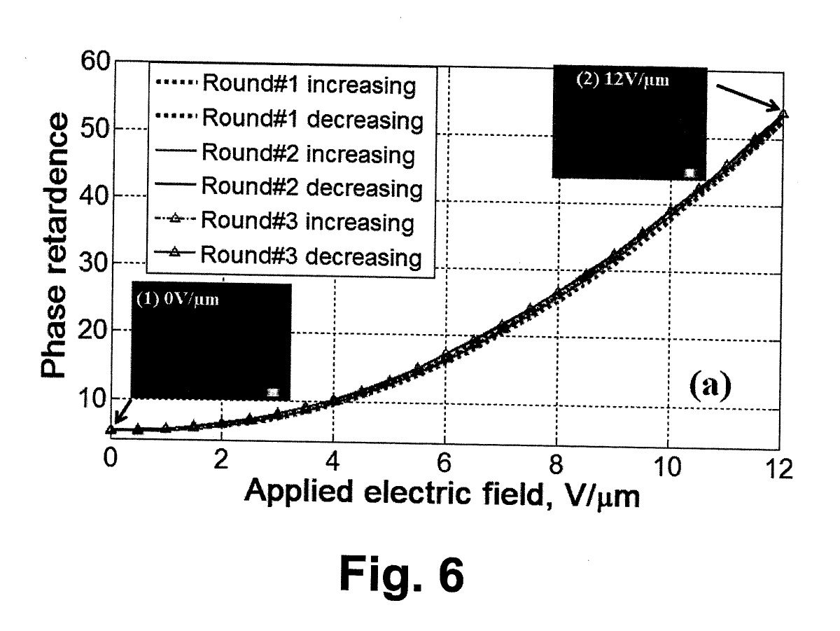

As demonstrated herein, the active layer 30 comprising liquid crystal material stabilized by a polymer network that is shaped by a blue phase using a washout/refill procedure exhibits negligible hysteresis (see FIG. 6). Additionally, it is shown herein that the active layer 30 provides unexpectedly fast switching speeds in cooperation with suitably fast control electronics 14. In view of these observations, it is disclosed herein to construct a high-speed electrooptic apparatus, such as the illustrative pixel 12 of the pixel array 10 of FIG. 1, comprising a phase retarder including a liquid crystal cell containing electrodes 36 and an active layer 30 comprising liquid crystal material stabilized by a polymer network that is shaped by a blue phase using a washout/refill procedure, in combination with electrical switching circuitry 14 operatively connected with the electrodes 36 of the phase retarder and configured in cooperation with the phase retarder to switch the phase retarder over its dynamic range with both a 10% to 90% rise time of less than 500 microseconds and a 90% to 10% decay time of less than 500 microseconds. In illustrative FIG. 1, the dynamic range is between a phase retardation level that corresponds to a minimum of light intensity transmitted through the optical assembly including active layer 30 and the pair of crossed linear polarizers 40, 42 and a phase retardation level that corresponds to the maximum of light transmission through the optical assembly. The pixel 12 of FIG. 1 includes no other birefringent optical element besides the active layer 30, and does not include any phase retardation-compensating optical element; accordingly, the minimum and maximum levels of light intensity transmission in pixel 12 correspond to the minimum and maximum of phase retardation with a phase shift of π. However, the optical assembly is optionally modified to include other optical elements and regimes, for example, to let light pass through the liquid crystal retarder multiple times to increase the phase shift as needed, and in such cases the dynamic range may correspond to a different retardation range. It is also contemplated to omit the crossed polarizers, in which case the dynamic range is suitably quantified in terms of the phase retardation range obtainable by biasing the electrodes 36 of the liquid crystal cell containing active layer 30. The response times were measured in the actually constructed devices reported herein by using light transmittance changes. The physical meaning of these times is that they describe the response dynamics of the liquid crystal structure to the applied electric field. Various approaches may be employed in measuring the switching over the dynamic range of the phase retarder; the examples reported herein use light intensity changes, measuring the time to switch the light intensity transmission between the levels of 10% and 90% and between 90% and 10%. Indeed, in actually constructed embodiments disclosed herein, in such a high-speed electrooptic apparatus the electrical switching circuitry can be readily configured in cooperation with the phase retarder to switch the phase retarder between the minimum phase retardation level and the maximum phase retardation level with both a 10%-to-90% rise time of 200 microseconds or less and a 90%-to-10% decay time of 200 microseconds or less over a temperature range of at least 30° C.

In an actually performed washout-and-refill fabrication procedure to manufacture an optical retarder including the active layer 30, the liquid crystal in blue phase was formed using a mixture of a nematic liquid crystal MLC2048 (Merck), chiral dopant S811 (Merck), reactive monomers RM257 (BDH, Ltd) and TMPTA (Aldrich), and photoinitiator IRG651 (Aldrich) with weight percentages 51 wt %, 36.1 wt %, 7.3 wt %, 5 wt %, and 0.6 wt %, respectively. The mixture was injected into a liquid crystal cell of thickness 3.8 micron in its isotropic phase. The liquid crystal cell included two glass substrates with no alignment layers. (In general, the devices disclosed herein do not employ alignment layers.) Temperature was controlled by a Linkam hot stage (with programmer Linkam TMS94). The mixture was cooled down at a rate of 0.2° C./min, and the blue phase was observed in a temperature range of 42° C. to 22° C. On heating, the blue phase was observed from 31° C. to 43° C. The material with a supercooled blue phase type I (BPI) state was kept at 24° C. and irradiated with ultraviolet (UV) light (wavelength 365 nm, intensity 1 mW/cm²) for 3 hours. UV irradiation triggered polymerization resulting in a three-dimensional (3D) periodic structure. The clearing temperature of the polymer-stabilized blue phase was 56° C.

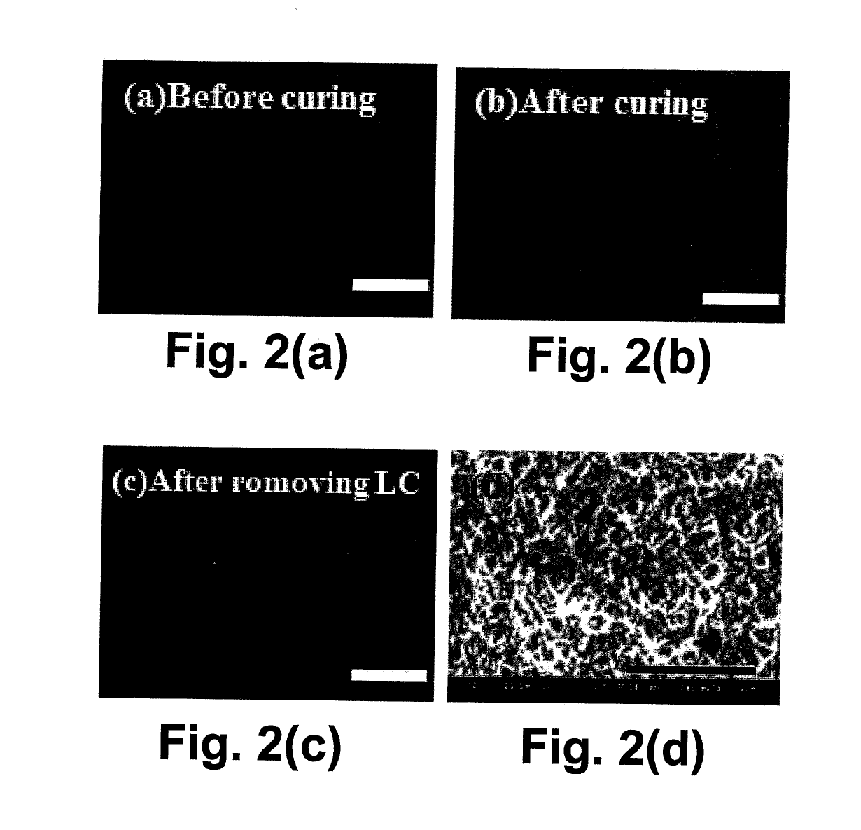

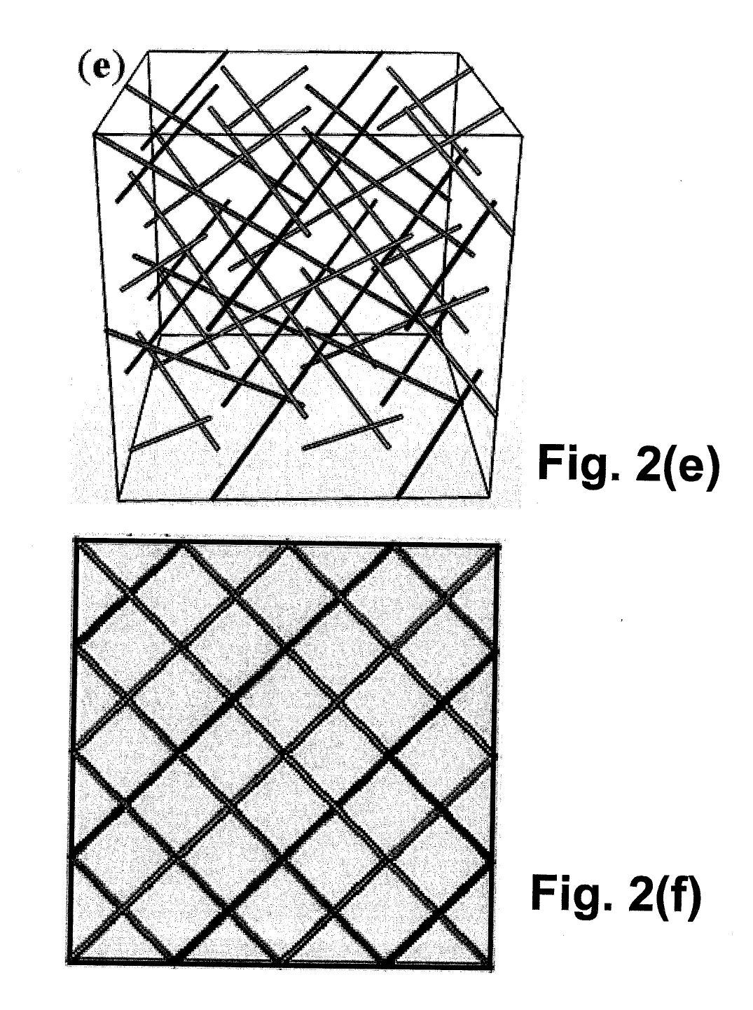

With reference to FIG. 2, polarizing optical microscope textures of the blue phase material in mixture with monomers are shown before photo-polymerization (FIG. 2(a)) and after photo-polymerization (FIG. 2(b)). FIG. 2(c) shows polarizing optical microscope texture after removing the liquid crystal. FIG. 2(d) shows the periodic polymer-network shaped by the blue phase under scanning electron microscopy (SEM). The scale bar in FIGS. 2(a)-(c) is 100 μm, and the scale bar in FIG. 2(d) is 2 μm. FIGS. 2(e) and 2(f) diagrammatically show the arrangement of disclination lines in BPI in a perspective view (FIG. 2(e)) and in a side view (FIG. 2(f)) which coincides with the SEM image of FIG. 2(d).

With continuing reference to FIG. 2, the texture of the polymer-stabilized blue phase under crossed polarizers is shown before and after curing in FIG. 2(a) and FIG. 2(b), respectively. After polymerization, the liquid crystal cell was placed in a solvent (hexane) for 20 hours to remove the unpolymerized components, and the texture under crossed polarizers is shown in FIG. 2(c). The residual hexane was evaporated by drying at room temperature. Some of the cells were disassembled and the extracted polymer membranes were examined by scanning electron microscopy (SEM). As seen in FIG. 2(d), the SEM texture demonstrates the formation of a periodic polymer network. To perform sample preparation for SEM, one substrate with polymer network of the disassembled cell was put on an aluminum stub with double-side tape. The edge of the substrate was conductively connected with alumina stub using silver gel. Then the sample was put into a sputtering machine to deposit a thin layer of gold (Au) nanoparticles with size around 20 nm. This conducting Au surface represents the topographical profile of the polymer-network. The SEM image of FIG. 2(d) shows a periodic structure with a typical size of pores around 200 nm. This polymer network, and the observed pore size of 200 nm, corresponds to an expected disclination network for the blue phase of type I used to shape the polymer network, diagrammatically shown in FIG. 2(e). Without being limited to any particular theory of operation, the shaping of the polymer network is believed to be due to preferential formation of the polymer at the cores of the disclinations.

During the refill process, the polymer networks that remained confined between two glass plates was employed. These cells were refilled with a commercial mixture E7 (EM Industries). The nematic phase of E7 is stable in the broad range between −30° C. and 58° C. It is nonchiral and thus cannot form the blue phase by itself. However, the E7 liquid crystal material disposed in the liquid crystal cell in contact with the blue phase-shaped polymer template shows textures very similar to that of the blue phase platelet textures, in the entire temperature range of the nematic phase.

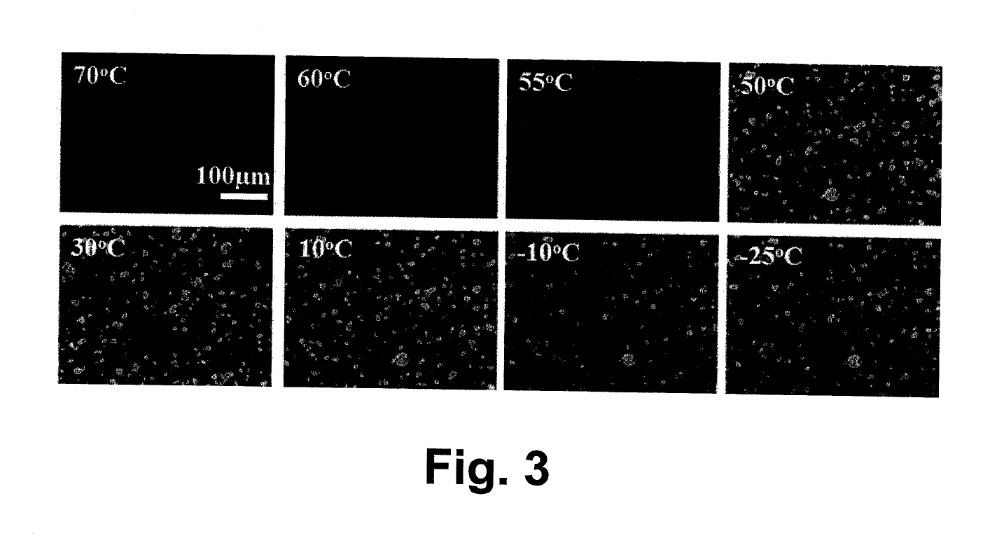

With reference to FIG. 3, polarizing optical microscope images are shown of the refilled blue phase-template E7 sample during cooling from isotropic to blue phase. The scale bar in FIG. 3 is 100 μm. Blue phase-templated E7 shows blue phase structure in a wide temperature range, between −25° C. and 55° C. as seen in FIG. 3. Small birefringence is observed even at temperatures somewhat higher than the temperature of the isotropic-to-nematic phase transition, apparently caused by a partial wetting of the glass substrates and of some portions of the polymer network. Therefore, the blue phase polymer template structure of E7 shows temperature stability over a range of about 88° C. which is much larger than the stable temperature range of the initial blue phase material prior to washout/refill processing.

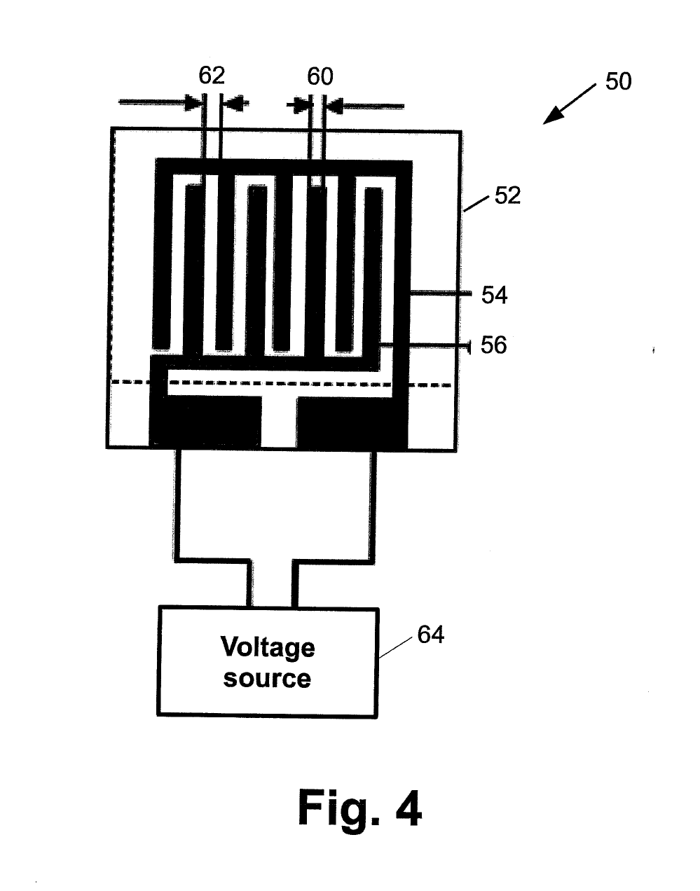

With reference to FIG. 4, to study the electro-optical performance, the blue phase templated E7 sample was prepared in an in-plane-switching (IPS) cell 50 with the same procedure described above. FIG. 4 diagrammatically shows an overhead (i.e. planar) view of the IPS cell 50. The IPS cell 50 includes two glass substrates 52 (not separately distinguishable in the overhead view of FIG. 4). One of the glass substrates 52 includes patterned indium tin oxide (ITO) electrodes including a pixel electrode 54 and a counter electrode 56, having an interdigitated arrangement shown in FIG. 4 with 10 μm electrode width 60 and 10 μm electrode space 62 between neighboring pixel and counter electrode segments. The IPS cells 50 were assembled with a second glass substrate, without ITO electrodes, using ball spacers to separate the glass substrates with a cell thickness of 3.8 μm (not visible in the overhead view of FIG. 4). That is, there is a 10 μm electrode width 60 and 10 μm electrode gap 62, and a 3.8 μm cell thickness. A voltage source 64 was connected across the pixel electrode 54 and counter electrode 56 to generate an in-plane electric field in the gaps 62.

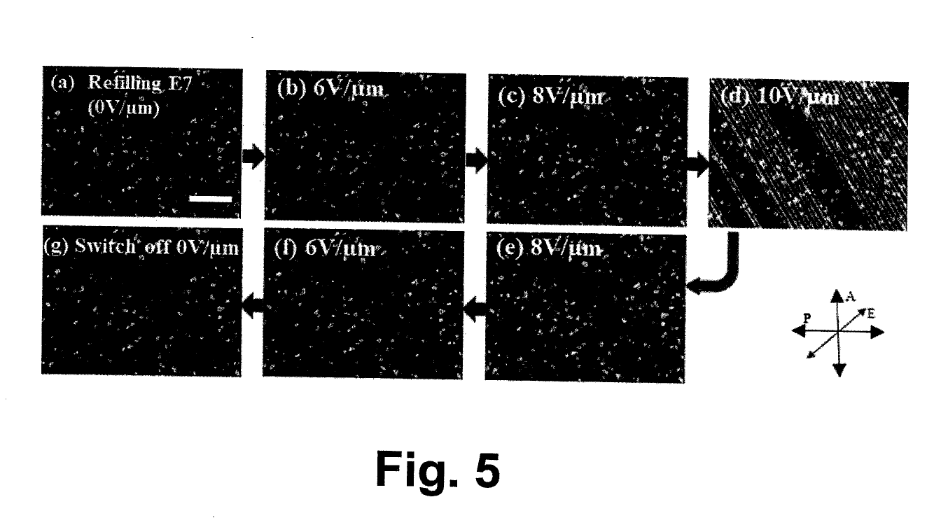

With reference to FIG. 5, polarizing optical microscope images are shown of the blue phase template E7 sample under applied voltage at room temperature. The sample has in-plane-switching (IPS) patterned electrodes 52, 54 as diagrammatically shown in FIG. 4, but tilted at about 45° orientation in the polarizing optical microscope images of FIG. 5. Thus, the electric field is at about 45°. Crossed polarizers corresponding to the crossed polarizers 40, 42 shown in FIG. 1 are employed to convert the phase retardation to gray scale intensity. A diagram in the lower-right of FIG. 5 shows the orientations of the polarizer (P), analyzer (A), and electric field (E). The scale bar in FIG. 5 is 100 μm. As seen in FIG. 5, under different applied voltages at room temperature, the sample shows electric-field switchable properties. FIG. 5(a) shows a polarizing optical microscope image of the sample after refilling with E7 nonchiral nematic liquid crystal material and before any applied voltage. FIGS. 5(b), 5(c), and 5(d) show polarizing optical microscope images of the sample with increasing applied voltage of 6 V/μm (FIG. 5(b)), 8 V/μm (FIGS. 5(c)), and 10 Vμm (FIG. 5(d)). FIGS. 5(e), 5(f), and 5(g) show polarizing optical microscope images of the sample with decreasing applied voltage of 8 V/μm (FIG. 5(e)), 6 V/μm (FIG. 5(f)), and back to 0 V/μm (FIG. 5(g)).

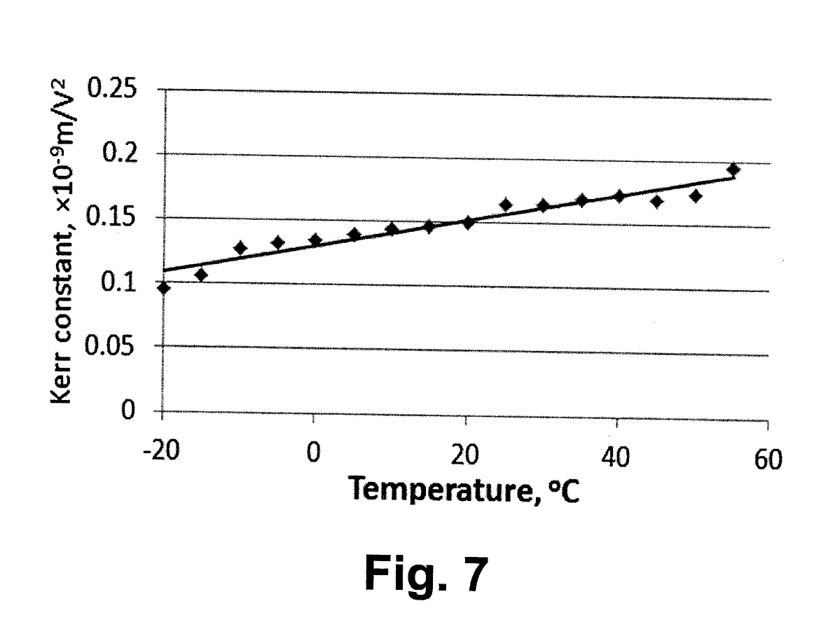

FIGS. 6 and 7 show phase retardance versus applied electric field by running three cycles from 0→12 Volts/μm and back 12→0 Volts/μm, measured using a quantitative polarized light microscope (LC-PolScope, Cambridge Research and Instrumentation, Woburn, Mass.). The LC-Polscope is a polarizing microscope in which the conventional optical compensator is replaced with an electrically-switchable liquid crystal-based universal compensator. See e.g. Oldenbourg et al., J Microsc-Oxford vol. 180 page 140 (1995); Shribak et al., Appl Optics vol. 42 no. 16 page 3009(2003). The liquid crystal (LC) compensator is used to quickly switch the polarization state of the illuminating monochromatic light at wavelength λ=546 nm. A digital camera captured raw images of the sample at circular and elliptical polarization settings that are used to calculate the retardance and in-plane orientation of the slow axis (director) in each pixel of the sample. As seen in FIG. 6, the blue phase template E7 sample has a low hysteresis since the phase retardance versus applied electric field curve is nearly the same in both the 0→12 Volts/μm and 12→0 Volts/μm sweeps for all three cycles (rounds). The measurement shown in FIG. 6 was done at 25° C. The electric field-induced phase retardance measurement was repeated at different temperatures, and the Kerr constant was estimated as shown in FIG. 7.

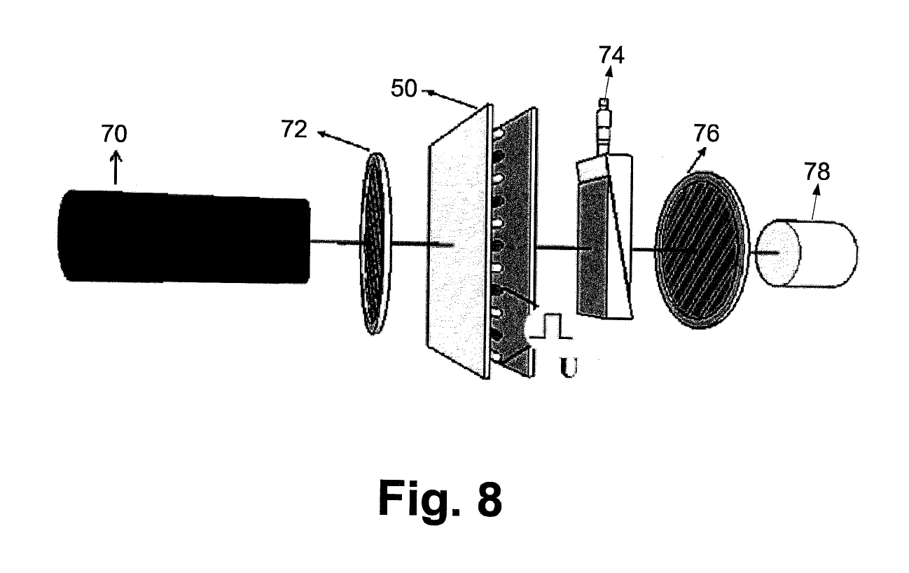

With reference to FIG. 8, an experimental setup is diagrammatically shown for measuring response time. The setup includes (in order along the optical train) a helium neon (HeNe) laser 70, a first 45° polarizer 72, the IPS cell 50 refilled with E7 liquid crystal material as shown in FIG. 4, a Soliel-Babinet compensator 74, a second 45° polarizer 76, and an optical detector 78.The voltage source 64 (see FIG. 4) applies a square pulse U to the electrodes of the IPS cell 50. To measure response time, the blue phase template E7 sample 50 was allowed to relax from an applied voltage and the dynamic relaxation process was recorded by a digital oscilloscope. Both rise time and decay time are determined by the transmittance change between 10% and 90%.

With reference to FIG. 9, the applied voltage U measured as a function of time by the digital oscilloscope is shown as the upper trace, and the normalized transmittance as a function of time as measured by the detector 78 is plotted as the lower trace. The 10%→490% rise time (τₒₙ) and the 90%→10% decay time (τ₀₁₁) are highlighted in the lower trace of FIG. 9. Both the rise time τₒₙ and the decay time τ_{off} are below 0.1 ms (that is, below 100 microseconds). The plot of FIG. 9 is for 25° C.

With reference to FIG. 10, the experiment of FIG. 9 was repeated at temperatures between 25° C. and 55° C., and the rise time τₒₙ and the decay time τ_{off} are plotted as a function of temperature. Both rise time τₒₙ and the decay time τ_{off} are below 200 microseconds in the tested temperature range between 25° C. and 55° C., which is a 30° range. Although not experimentally tested, the relatively flat curves at the lower end indicate that both τₒₙ and τ_{off} remain below 200 microseconds for temperatures below 25° C.

Disclosed herein are fast electro-optic switching (response time 0.1 millisecond or faster) of a nematic liquid crystal in a polymer template shaped by blue phase. The template is formed by photo-polymerizing a photosensitive component of a liquid crystal blue phase mixture; the polymer template memorizes the periodic structure of the blue phase with cubic symmetry and submicron period. In the field-free state, the nematic in polymer template is optically isotropic. The applied electric field causes non-zero optical retardance. The approach thus combines beneficial structural and optical features of the blue phase (spatial cubic structure with submicron periodicity) and superior thermodynamic stability and electrooptic switching ability of the nematic filler.

The illustrative samples have blue phase type I (BPI) body-centered cubic structure. However, the disclosed results are also expected to apply to washout/refill devices with blue phase type II (BPII) simple cubic structure. While a nonchiral nematic liquid crystal material was used as the refill material, other refill liquid crystal materials such a nonchiral nematic liquid crystal material, chiral nematic liquid crystal material, a chiral smectic liquid crystal material, or so forth are expected to provide similarly fast electro-optic switching (due to the small pore size of about 200 nm), and the refill liquid crystal material can be chosen for desired properties such as thermodynamic stability.

It will be appreciated that various arrangements of the above-disclosed and other features and functions, or alternatives thereof, may be desirably combined into many other different systems or applications. It will be further appreciated that various presently unforeseen or unanticipated alternatives, modifications, variations or improvements therein may be subsequently made by those skilled in the art which are also intended to be encompassed by the following claims.

1. An apparatus comprising:
a phase retarder including a liquid crystal cell containing electrodes and an active layer comprising liquid crystal material stabilized by a polymer network that is shaped by a blue phase using a washout/refill procedure; and
electrical switching circuitry operatively connected with the electrodes of the phase retarder and configured in cooperation with the phase retarder to switch the phase retarder over its dynamic range with both a 10%-to-90% rise time of less than 500 microseconds and a 90%-to-10% decay time of less than 500 microseconds.

2. The apparatus of claim 1 wherein the electrical switching circuitry is configured in cooperation with the phase retarder to switch the phase retarder over its dynamic range with both a 10%-to-90% rise time of 200 microseconds or less and a90%-to-10% decay time of 200 microseconds or less.

3. The apparatus of claim 1 wherein the electrical switching circuitry is configured in cooperation with the phase retarder to switch the phase retarder over its dynamic range with both a 10%-to-90% rise time of 200 microseconds or less and a 90%-to-10% decay time of 200 microseconds or less over a temperature range of at least 30° C.

4. The apparatus of claim 1 wherein the electrical switching circuitry is configured in cooperation with the phase retarder to switch the phase retarder over its dynamic range with both a 10%-to-90% rise time of less than 500 microseconds and a 90%-to-10% decay time of less than 500 microseconds over a temperature range of at least 30° C.

5. The apparatus of claim 1 wherein the dynamic range of the phase retarder is defined as the phase retardation range obtainable by biasing the electrodes of the phase retarder.

6. The apparatus of claim 1 wherein the apparatus further comprises:
polarizers disposed on opposite sides of the phase retarder;
wherein the dynamic range of the phase retarder is defined as the range of light transmission intensity through the optical assembly comprising the phase retarder and the polarizers obtainable by biasing the electrodes of the phase retarder.

7. The apparatus of claim 1 wherein the polymer network has pores of less than or about 200 nm.

8. The apparatus of claim 1 wherein the liquid crystal material comprises a nonchiral nematic liquid crystal material.

9. The apparatus of claim 1 wherein the liquid crystal material comprises a nonchiral nematic liquid crystal material, a chiral nematic liquid crystal material, or a chiral smectic liquid crystal material.

10. The apparatus of claim 1 wherein the phase retarder does not include an alignment layer.

11. The apparatus of claim 1 wherein the polymer network comprises:
a polymer network that is shaped by a blue phase of type I having a body-centered cubic structure using a washout/refill procedure.

12. The apparatus of claim 1 wherein the washout/refill procedure comprises:
filling the liquid crystal cell with a first mixture comprising a nematic liquid crystal, a chiral dopant, a reactive monomer, and a photoinitiator;
controlling temperature of the liquid crystal cell containing the first mixture to convert the first mixture to a blue phase;
irradiating the liquid crystal cell with the first mixture in the blue phase with ultraviolet light at a wavelength and exposure duration effective to polymerize the reactive monomer to form a three-dimensional polymer network inside the liquid crystal cell;
disposing the liquid crystal cell in a solvent to wash out the first mixture while leaving the three-dimensional polymer network in the liquid crystal cell; and
refilling the liquid crystal cell with the liquid crystal material of the active layer.

13. The apparatus of claim 1 further comprising:
a display including:
an array of pixels, each pixel of the array of pixels including an instance of said phase retarder sandwiched between polarizers;
said electrical switching circuitry comprising pixel driver circuitry operatively connected with the electrodes of the phase retarder of each pixel of the array of pixels; and
a display controller comprising an electronic component programmed to generate and communicate to the electrical switching circuitry electrical signals indicating gray scale values for the pixels of the array of pixels;
wherein the dynamic range of the phase retarder is defined as the range of gray scale intensity obtainable by biasing the electrodes of the phase retarder.

14. A method comprising:
providing a phase retarder including a liquid crystal cell containing electrodes and an active layer comprising liquid crystal material stabilized by a polymer network that is shaped by a blue phase using a washout/refill procedure; and
applying voltages to the electrodes of the phase retarder to switch the phase retarder over its phase retardation dynamic range obtainable by biasing the electrodes of the phase retarder with both a 10%-to-90% rise time of less than 500 microseconds and a 90%-to-10% decay time of less than 500 microseconds.

15. The method of claim 14 wherein the applying comprises:
applying voltages to the electrodes of the phase retarder to switch the phase retarder over its phase retardation dynamic range with both a 10%-to-90% rise time of 200 microseconds or less and a 90%-to-10% decay time of 200 microseconds or less over a temperature range of at least 30° C.

16. The method of claim 14 wherein the polymer network has pores of less than or about 200 nm.

17. The method of claim 14 wherein the liquid crystal material comprises a nonchiral nematic liquid crystal material, a chiral nematic liquid crystal material, or a chiral smectic liquid crystal material.

18. The method of claim 14 wherein the providing comprises:
shaping the polymer network by a blue phase of type I having a body-centered cubic structure using a washout/refill procedure comprising:
filling the liquid crystal cell with a first mixture comprising a nematic liquid crystal, a chiral dopant, a reactive monomer, and a photoinitiator;
controlling temperature of the liquid crystal cell containing the first mixture to convert the first mixture to a blue phase;
irradiating the liquid crystal cell with the first mixture in the blue phase with ultraviolet light at a wavelength and exposure duration effective to polymerize the reactive monomer to form a three-dimensional polymer network inside the liquid crystal cell;
disposing the liquid crystal cell in a solvent to wash out the first mixture while leaving the three-dimensional polymer network in the liquid crystal cell; and
refilling the liquid crystal cell with the liquid crystal material of the active layer.

19. An apparatus comprising:
a phase retarder including a liquid crystal cell containing electrodes and an active layer comprising liquid crystal material stabilized by a polymer network that is shaped by a blue phase using a washout/refill procedure; and
electrical switching circuitry configured to operate the phase retarder at a switching speed of less than 500 microseconds for both rise time and decay time.

20. The apparatus of claim 19 wherein the electrical switching circuitry is configured to operate the phase retarder at a switching speed of 200 microseconds or less for both rise time and decay time

21. The apparatus of claim 19 wherein the polymer network has pores of less than or about 200 nm.

22. The apparatus of claim 21 wherein the liquid crystal material comprises a nonchiral nematic liquid crystal material.

23. The apparatus of claim 21 wherein the liquid crystal material comprises a nonchiral nematic liquid crystal material, a chiral nematic liquid crystal material, or a chiral smectic liquid crystal material.

24. The apparatus of claim 21 wherein the liquid crystal cell does not include an alignment layer.

25. The apparatus of claim 21 wherein the polymer network comprises:
a polymer network that is shaped by a blue phase of type I having a body-centered cubic structure using a washout/refill procedure.
